(19) United States
(12) Patent Application Publication
(10) Pub. No.: US 2008/0189108 A1
(43) Pub. Date: Aug. 7, 2008

(54) Text messaging in a telephony network

(75) Inventor: Kobi Atar, Beer Yaakov (IL)

Correspondence Address: SUGHRUE MION, PLLC, 2100 PENNSYLVANIA AVENUE, N.W., SUITE 800, WASHINGTON, DC, 20037, US

(73) Assignee: COMVERSE LTD., Tel Aviv (IL)

(21) Appl. No.: 11/702,080

(22) Filed: Feb. 5, 2007

(51) Int. Cl. G10L 15/26

(52) U.S. Cl. 704/235

(57) ABSTRACT

An apparatus including a capturer and a converter. The capturer is configured to capture at least one word spoken by a calling party of a phone call in accordance with a predetermined capturing policy. The converter is in communication with the capturer and configured to automatically convert at least one of the at least one captured word into a textual sequence.

### BACKGROUND OF THE INVENTION

1. Field of the Invention

The present invention relates to phone calls. More particularly, but not exclusively, the present invention relates to a method and apparatus for text messaging in a telephony network.

2. Description of the Background Art

Currently, cellular telephone users enjoy a variety of smart phones. Smart phones support a variety of advanced services and features. A smart phone may have a central processing unit (CPU) for supporting the services and features, many of which are usually found in personal computers. The functions and features include email, web browsing, calendars, etc.

One of the extremely widespread and popular services among cellular telephony users today, is the Short Messaging Service (SMS). Short Message Service (SMS) is a service available on most digital mobile phones that permits the sending of short messages (also known as text messages, messages, or more colloquially SMS's, texts or even txts) between mobile phones, other handheld devices, and even landline phones.

Short messaging has developed very rapidly throughout the world. By mid-2004 text messages were being sent at a rate of 500 billion messages per annum, at an average cost of USD 0.10 per message. The sent text messages generate revenues in excess of USD 50 billion for mobile telephone operators, and represent about 100 text messages for every person in the world.

Growth in SMS usage has been rapid. For example, 250 billion short messages were sent in 2001 whereas just 17 billion were sent in 2000. SMS is particularly popular in Europe, Asia, and Australia. In Japan and Korea other cellular short messaging services such as i-mode are typically used. SMS popularity has grown to a sufficient extent that the term texting (used as a verb meaning the act of mobile phone users sending short messages back and forth) has entered the common lexicon. In China, SMS is very popular, and has brought service providers large profits. Only 18 billion short messages were sent in China in 2001.

A relatively new concept in the cellular telephony industry is the concept of Advanced Messaging Services. Advanced Messaging Services enhance SMS with new functions.

For example, U.S. Pat. No. 5,327,486, which is entitled “Method and System for Managing Telecommunications such as Telephone Calls,” issued to Wolff et al. on Jul. 5, 1994, and incorporated herein by reference in its entirety, discloses a personal telephone manager (PTM) (12) The system described by Wolff uses out-of-band, wireless, two-way signaling, messaging, and alerting to screen, control, route, and respond to incoming telephone calls and to communicate called party text messages in auditory form to the caller. Through use of an out-of-band signaling/messaging path (16), the PTM (12) frees the called party from the need to maintain telephone network connectivity, from having to inform others of his/her current location, and from having to subscribe to and use cellular telephone service.

With Wolff, the called party can rely on the availability of existing low bandwidth wide area two-way wireless data services, which make efficient and cost effective use of available radio spectrum. A two-way wireless data messaging to a portable computer (18) equipped with radio transceivers is also provided. This feature enables the system to provide a set of real time options including: call screening by the called party based on information identifying the caller's telephone number, call redirection to a wire-line or wireless telephone number as specified by the called party; call redirection to a third party or to a voice mail system; or the return of a text message specified by the called party and delivered to the caller in an auditory form.

U.S. Pat. No. 6,408,063, which is entitled “Method and Arrangement for Complementing a Telephone Connection with Additional Information” issued to Slotte et al. on Jun. 18, 2002, and incorporated herein by reference in its entirety, discloses a System for communication of additional information in close association with a telephone connection. With the system described by Slotte, a called party may answer a phone call either by a call rejection together with a short User-to-User signaling (UUS) message indicating the cause of the rejection, or by accepting the call. UUS is a procedure recently disclosed as a supplementary service in some advanced telephone systems. With Slotte, the called party may also manually or automatically send a UUS message to the calling party, for informing the calling party about the situation of the called party. The selection of the UUS message to be sent may be based on the identification of the calling party.

U.S. Pat. No. 6,408,177, which is entitled “System and method for call management with voice channel conservation”, issued to Parikh on Jun. 18, 2002, and incorporated herein by reference in its entirety, describes a system and method for providing a call management service subscriber with options for handling incoming calls without using voice channel resources. When an incoming call is received by the call management system, caller information and menu options are provided to the subscriber in text form on a display, using a data channel, rather than in spoken form over a voice channel. This conserves air time and network resources while providing the subscriber with call handling options in a convenient and user-friendly form.

U.S. Pat. No. 6,421,707, which is entitled “Wireless Multi-media Messaging Communications Method and Apparatus”, issued to Miller et al. on Jul. 16, 2002, and incorporated herein by reference in its entirety, describes a wireless multimedia messaging communications method and apparatus that permits a subscriber to a wireless telecommunications service to receive and generate multimedia messages from known wireless personal communications devices (i.e., cellular/PCS telephones). A multimedia message may be received by the network and selectively delivered to a subscriber of the wireless service. Upon receipt of the message, the network determines an appropriate action to take with respect to the message based upon a profile of the subscriber.

U.S. Pat. No. 6,701,162, which is entitled “Portable electronic telecommunication device having capabilities for the hearing-impaired”, issued to Everett on Mar. 2, 2004, and incorporated herein by reference in its entirety, describes a portable electronic device having telecommunication capabilities for use by a hearing-impaired user. The device includes a computer platform having storage for one or more programs, a display for displaying at least alphanumeric text, and at least a speech recognition program that is resident and selectively executable on the computer platform. When a communication connection is established with a communicating party, the speech recognition program translates the words of the calling party into equivalent text and displays the text on the display. The device can also include a text-to-speech program that translates text input by the user of the device into synthetic speech for transmission from the device to the communicating party.

U.S. Pat. No. 6,741,678, which is entitled “Method and System for Sending a Data Response from a Called Phone to a Calling Phone”, issued to Cannell on May 25, 2004, and incorporated herein by reference in its entirety, describes a method and communication system for sending a data response from a called phone to a calling phone in response to a call request from the calling phone. The calling phone sends a call request to the called phone. The call request is a request to establish a communication between the called phone and the calling phone on a call path. If the called phone decides not to answer the call request, the called phone can send a data message to the calling phone. If the calling phone is data-capable, the data message is sent directly to the calling phone. If the calling phone is not data-capable, the data message is sent to a server that converts the data message to a voice message and sends the voice message to the calling phone. The calling phone can send a message back to the called phone in response to the data message sent from the called phone. If the calling phone is not data-capable, the response message is sent to a server that converts the voice message to a data message and sends the data message to the called phone. If the calling phone is data capable, the calling phone sends the response data message directly to the called phone.

U.S. Pat. No. 6,823,184, which is entitled “Personal Digital Assistant for Generating Conversation Utterances to a Remote Listener in Response to a Quiet Selection”, issued to Nelson on Nov. 23, 2004, and incorporated herein by reference in its entirety, discloses a user who conducts a telephone conversation without speaking. The user conducts the conversation by moving the participant in the public situation to a quiet mode of communication, in the PDA (Personal Digital Assistant) (e.g., keyboard, buttons, touch screen). All the other participants are allowed to continue using their usual audible technology (e.g., telephones) over the existing telecommunications infrastructure. The quiet user interface transforms the user's silent input selections into equivalent audible signals that may be directly transmitted to the other parties in the conversation.

U.S. Pat. No. 6,850,604, which is entitled “Method and System for Sending a Data Message to a Calling Phone while Communicating with a First Phone”, issued to Cannell et al. on Feb. 1, 2005, and incorporated herein by reference in its entirety, discloses a method and communication system for sending a data message from a called phone to a calling phone while maintaining an active communication between the called phone and a first phone. The calling phone sends a call request to the called phone while the called phone is involved in an active communication with the first phone. The called phone sends a data message to the calling phone in response to the call request. The data message is sent while maintaining an active call with the first phone, so that the first phone is not placed “on hold”.

U.S. Patent Publication No. 2005/0048992, which is entitled “Multimode Voice/screen Simultaneous Communication Device”, filed by Wu et al. on Apr. 17, 2004, and incorporated herein by reference in its entirety, discloses a communication device capable of enabling a user to select whether he wants to use voice communications, text communications or voice/text communications to communicate with a remote communication device used by a person or an automated phone service. Wu also describes methods for making and using the communication device.

However, current methods are limited with respect to the options available to a calling party of a phone call unanswered by the called party, such as leaving a voice message, or trying to call the called party later. There is thus a widely recognized need for, and it would be highly advantageous to have, a system devoid of all or some of the above limitations.

### SUMMARY OF THE INVENTION

In one exemplary embodiment, the present invention relates to an apparatus for call enhancement in association with telephone calls in a telephony network. The apparatus includes a capturer configured to capture at least one word spoken by a calling party of a phone call according to a predetermined capturing policy. A converter is associated with the capturer and configured to automatically convert at least one of the at least one captured word into a textual sequence.

In a second exemplary embodiment, the present invention relates to a method for call enhancement in association with telephone calls in a telephony network. The method includes capturing at least one word spoken by a calling party of a phone call. The capturing is performed according to a predetermined capturing policy. The method further includes automatically converting at least one of the at least one captured word into a textual sequence.

In a third exemplary embodiment, the present invention relates to a system for call enhancement in association with telephone calls in a telephony network. The system includes a capturer deployed in the telephony network and configured to capture at least one word spoken by a calling party of a phone call according to a predetermined capturing policy. A converter is in communication with the capturer and configured to automatically convert at least one of the at least one captured word into a textual sequence A client agent is installed at a remote unit and configured to communicate with the capturer in order to trigger the capturing of the words by the capturer.

In a fourth exemplary embodiment, the present invention relates to a client agent embodied on a computer readable media and installable on a mobile telephony device. The client agent is configured to communicate with an apparatus in order to trigger capturing of words spoken by a calling party to a text message, and is further configured to receive the text message from the apparatus and present the text message on a screen of the mobile telephony device.

Other exemplary embodiments and advantages of the invention will be apparent from the following description and the appended claims.

### BRIEF DESCRIPTION OF THE DRAWINGS

FIG. 1 is a simplified block diagram showing a first apparatus for text messaging in a telephony network in accordance with an exemplary embodiment of the present invention.

FIG. 2 is a simplified block diagram showing a second apparatus for text messaging in a cellular telephony network in accordance with an exemplary embodiment of the present invention.

FIG. 3 is a simplified block diagram illustrating an exemplary architecture of a cellular network having an apparatus for text messaging in a telephony network in accordance with an exemplary embodiment of the present invention.

FIG. 4 is a simplified block diagram illustrating an exemplary system for text messaging in a telephony network in accordance with an exemplary embodiment of the present invention.

FIG. 5 is a flowchart illustrating a first method for text messaging in a telephony network in accordance with an exemplary embodiment of the present invention.

FIG. 6 is a flowchart illustrating a second method for text messaging in a telephony network in accordance with an exemplary embodiment of the present invention.

FIG. 7 illustrates messages presented on a called party's handset screen in accordance with an exemplary embodiment of the present invention.

### DETAILED DESCRIPTION OF THE PREFERRED EMBODIMENTS

Unless otherwise defined, all technical and scientific terms used herein have the same meaning as commonly understood by one of ordinary skill in the art to which this invention belongs. The materials, methods, and examples provided herein are illustrative only and not intended to be limiting.

When a calling party initiates a phone call towards a called party, the called party may answer the call. Occasionally, if the called party cannot answer the phone (for example, when the called party is in a middle of an important meeting), the calling party may be allowed to leave a voice message on the called party's answering machine.

In accordance with one exemplary embodiment of the present invention, when a call initiated by a cellular telephony calling party is not answered for a predetermined period of time, the calling party may be allowed to speak for a few seconds or minutes. For example, the called party may leave a voice message in a dedicated voice mail server. Then, one or more of the words spoken by the calling party may be automatically converted to a textual sequence of words. Finally, the sequence of words may be sent to the called party as a textual message, such as a SMS message.

In another example, when the called party is in a noisy environment and cannot hear the voice of the calling party, the called party may ask that the calling party be routed to a dedicated voice mail server where the calling party may leave a voice message. Then, one or more of the words spoken by the calling party may be automatically converted to a textual sequence of words. Finally, the sequence of words may be sent to the called party as a textual message, such as a Short Message Service (SMS) message.

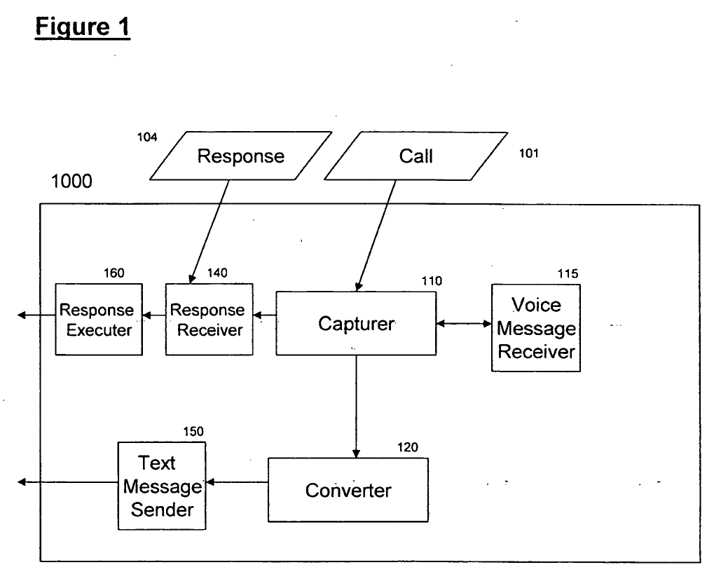

Reference is now made to FIG. 1, which is a simplified block diagram showing a first apparatus for text messaging in a telephony network in accordance with an exemplary embodiment of the present invention. Apparatus 1000 includes a capturer 110 deployed in a telephony network, such as a cellular telephony network. The capturer 110 captures one or more words spoken by a calling party of a phone call 101 initiated by the calling party, according to a capturing policy predefined by an operator or administrator of the apparatus 1000. For example, a capturing policy may dictate that, if the phone call is not answered for thirty seconds, the calling party is allowed to speak, and the words spoken by the calling party are to be captured by the capturer 110. Optionally, the calling party is allowed to leave a voice message in a voice message receiver 115, which is in communication with the capturer 110. In the voice message, the calling party 110 may speak the words. The words spoken by the calling party are captured by the capturer 110, and are temporarily stored in the voice message receiver 115.

Apparatus 1000 also includes a converter 120 in communication with the capturer 110. The converter 120 automatically converts the captured words spoken by the calling party into a textual sequence that includes one or more of the captured words. Preferably, the converter automatically converts all the words spoken by the calling party in the voice message into words in the textual sequence. The conversion of the word(s) spoken by the calling party into the textual sequence of words may be carried out using known in the art speech-to-text conversion methods, as described in further detail hereinbelow.

In the embodiment shown in FIG. 1, apparatus 1000 also includes a text message sender 150 in communication with the converter 150. The text message sender 150 sends a text message containing the textual sequence of words to the called party. For example, the text message sender 150 may send the sequence of words as a SMS message. Upon receiving the text message containing the textual sequence, the called party may decide to issue a response order 104. The response order 104 may include, but is not limited to: an SMS message to be sent to the called party, a call back to the calling party, an order to send a voice message prepared in advanced to the calling party, or an e-mail message to be sent to the called party.

In one embodiment, apparatus 1000 also includes a response receiver 140 in communication with the capturer 110, as shown in FIG. 1. The response receiver 140 receives the response order 104 from the called party. Apparatus 1000 may further include a response executer 160 in communication with the response receiver 140. The response executer 160 executes the response order 104. For example, the response executer 160 may send an SMS message received from the called party to the calling party, connect a call back between the called party and the calling party, send a voice message prepared in advanced (by the called party) to the calling party, or send an e-mail message received from the called party to the calling party, in accordance with the response order 104 received by the response receiver 140.

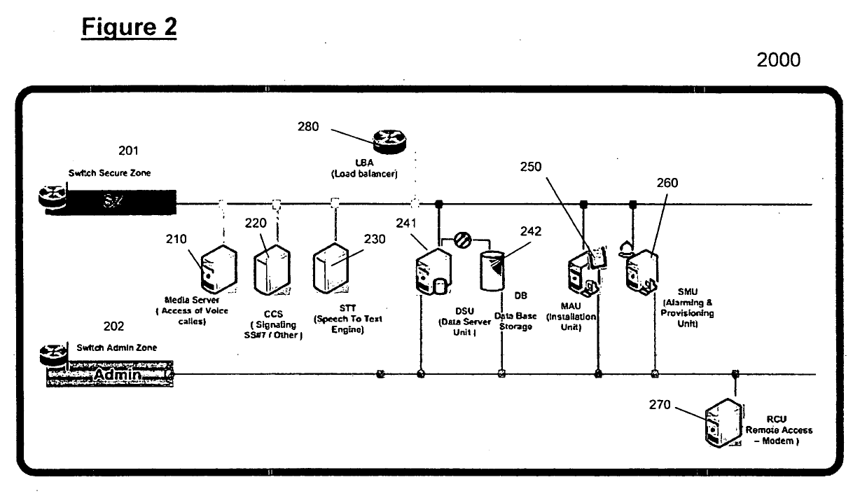

Reference is now made FIG. 2 which is a simplified block diagram showing a second apparatus for text messaging in a cellular telephony network in accordance with an exemplary embodiment of the present invention. Apparatus 2000 includes a media server 210 and a Call Control Server (CCS) 220 used for implementing the capturer 110 described above with respect to FIG. 1. When a called party does not answer a cellular phone call, the calling party of the call may be allowed to speak for a predetermined period of time. The media server 210 captures the words spoken by the calling party, which may be, for example, in a voice message, as described in further detail for the capturer 110 hereinabove.

The CCS 220 captures control data pertaining to the call, such as SS7 messages used for controlling to the call. SS7 is a telecommunications protocol that provides out-of-band signaling and a data interface between phone company switches. The spoken words and the control data are captured from a Mobile Switching Center (MSC) using a switch secured zone 201. The switch secured zone 201 may be implemented as a demilitarized zone (DMZ), as known in the art.

The voice and control data may be transmitted from the MSC using a high speed data line, such as a T1 data line (typically in the US), an E1 data line (typically in Europe), or any other data line, as known in the art. The spoken words are forwarded to a Speech-to-Text engine (STT) 230 in communication with the media server 210. The STT 230 is used for implementing the converter 120 described hereinabove. The STT 230 may automatically convert the captured words spoken by the calling party into a textual sequence comprising one or more of the captured words.

In one embodiment, the STT 230 automatically converts all the words spoken by the calling party in the voice message into words in the textual sequence. The conversion of the words) spoken by the calling party into the textual sequence of words may be carried out using known in the art speech-to-text conversion methods, as described in further detail hereinbelow.

The textual sequence of words is sent to the called party, using the media server 210 and the CCS 220. In one embodiment, a handshake protocol is implemented between the calling party and the called party before the textual text is sent to the called party.

Apparatus 2000 may further include a data server unit (DSU) 241, which is in communication with a database storage device 242. The DSU 241 and database storage device 242 are used for storing profiles of users who choose to subscribe to services provided by the apparatus 2000, to store any other administrative or operative data, etc.

In the embodiment shown in FIG. 2, apparatus 2000 also includes administrative tools. For example, apparatus 2000 may include a monitoring and installation unit (MAU) 250. The MAU 250 is used by an operator or administrator of the apparatus 2000 for monitoring the operation of the apparatus 2000 and for installing the STT engine 230, or other parts of the apparatus 2000.

Apparatus 2000 may further include an alarming and provisioning unit (also referred to as System Management Unit—SMU) 260. The alarming and provisioning unit 260 automatically and autonomously monitors the operation of the apparatus 2000. Upon detecting a malfunction or any other condition, the alarming and provisioning unit 260 sends control messages to predefined recipients, such as, for example, an operator and administrator of the apparatus 2000, or a technical manager.

Continuing with FIG. 2, apparatus 2000 may further include a Secure Zone switch 201 for controlling secured access to the media server 210, CCS 220, STT 230, DSU 241, database storage 242, MAU 250, and SMU 260. Apparatus 2000 may also include an administration zone switch 202 for controlling secured access for administration. The Administration zone switch 202 allows access to administration components of the system which are: the DSU 241, Database storage 242, MAU 250, and SMU 260. A remote technician, operator, or administrator, may be allowed to remotely access the apparatus 2000 through the administration zone switch 202. For example, a technician may remotely access the apparatus 2000 using a remote access modem 270, as known in the art.

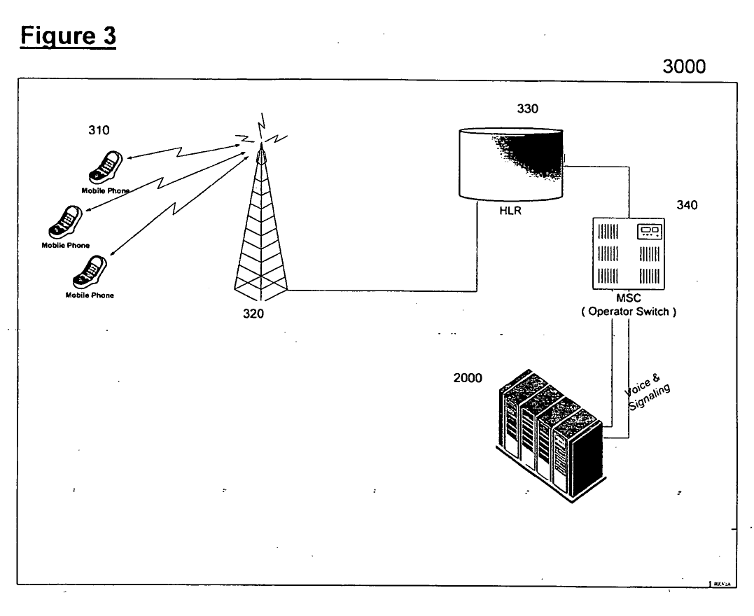

Reference is now made to FIG. 3, which is a simplified block diagram illustrating an exemplary architecture of a cellular network having an apparatus for text messaging in a telephony network in accordance with an exemplary embodiment of the present invention. A cellular telephony calling party may use his mobile phone 310 to initiate a call towards a called party. The mobile phone is connected using a cellular antenna 220 at the cell where the mobile phone is present. The call is routed using cellular telephony network units, which may include, but are not limited to: a Home Location Register 330, which is the functional unit responsible for managing mobile subscribers, and an Mobile Switching Center (MSC) 340. The MSC is a location which provides the mobile switching function in a cellular network. The MSC 340 switches all calls between the mobile and the PSTN and other mobiles.

The MSC 340 is in communication with the apparatus 2000, using one or more E1 lines, T1 lines, or any other data communication lines known in the art. The apparatus 2000 captures voice and control data, including words spoken by the calling party, when the called is not answered, as described in further detail hereinabove.

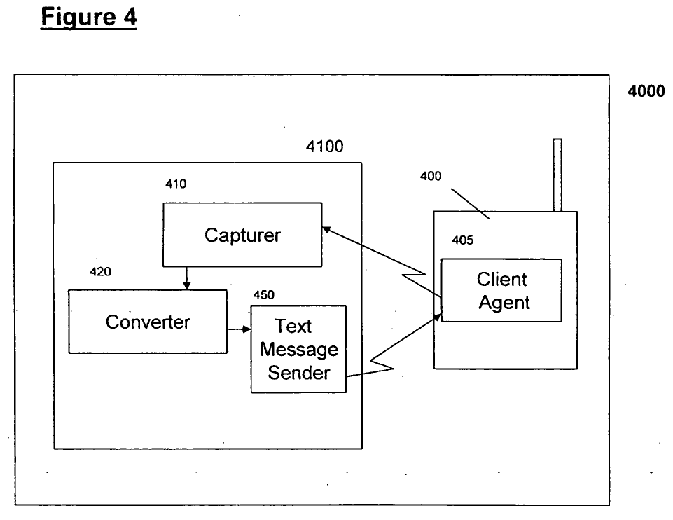

Reference is now made to FIG. 4, which is a simplified block diagram illustrating an exemplary system for text messaging in a telephony network in accordance with an exemplary embodiment of the present invention. System 4000 includes a client agent 405 installed on a mobile unit 400, such as a cellular telephone. The client agent 405 allows a called party using the mobile unit 400 to request the performance of voice-to-text conversion on the incoming call. The client agent 405 communicates the request made by the called party to an apparatus 4100, which may be installed at a central location in the cellular telephony network.

Apparatus 4100 includes a capturer 410, which communicates with the client agent 405, for receiving the request made by the called party, as described hereinabove. Upon receiving the called party's request, the capturer 410 captures one or more words the calling party is allowed to speak, such as, for example, in a voice message, as described in further detail hereinabove. The apparatus 4100 also includes a converter 420, in communication with the capturer 410. The converter 420 automatically converts the captured words spoken by the calling party into a textual sequence that includes one or more of the captured words.

The converter may automatically convert all the words spoken by the calling party in the voice message into words in the textual sequence. The conversion of the word(s) spoken by the calling party into the textual sequence of words may be carried out using known in the art speech-to-text conversion methods, as described in further detail hereinbelow.

Apparatus 4100 may also include a text message sender 450 in communication with the converter 420. The text message sender 450 sends a text message containing the textual sequence of words to the called party. For example, the text message sender 450 may send the sequence of words in a SMS message. Upon receiving the text message containing the textual sequence of words, the called party may decide to issue a response order. The response order may include, but is not limited to: an SMS message to be sent to the calling party, a call back to the calling party, an order to send a voice message prepared in advanced to the calling party, or an e-mail message to be sent to the calling party.

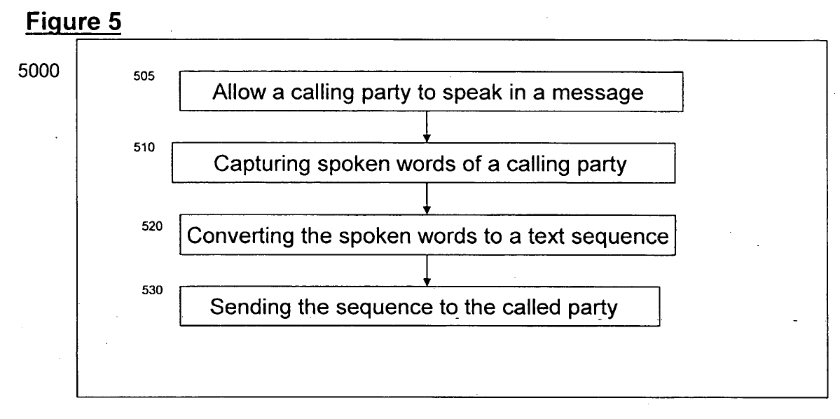

Reference is now made FIG. 5, which is a flowchart illustrating a first method for text messaging in a telephony network, in accordance with an exemplary embodiment of the present invention. In method 5000, words spoken by a calling party of an unanswered phone call are captured 510, for example by the capturer 110 described in further detail hereinabove. For example, an administrator of the apparatus 1000 may define that if a phone call is initiated towards a called party who subscribes to the service implemented by the apparatus 1000 is not accepted by the called party for twenty seconds, the calling party is allowed to leave a voice message in which he speaks 505 for twenty seconds.

The voice message may be captured by the capturer 110, and stored in the voice message receiver 115, as described in further detail hereinabove. Then the captured spoken words 510 are automatically converted 520 into a textual sequence of words. The textual sequence of words may include one or more of the words spoken by the calling party. The textual sequence of words may include all the words spoken by the calling party in the message. The automatic conversion of the spoken words into the textual sequence may be carried out using any of known in the art speech-to-text conversion techniques.

Usually, known in the art speech-to-text conversion techniques are based on speech recognition techniques. For example, the speech recognition techniques may use a Hidden Markov Model (HMM). A HMM is a known in the art statistical model in which the system being modeled is assumed to be a Markov process with unknown parameters. With HMM, the challenge is to determine the hidden parameters from the observable parameters. The extracted model parameters can then be used to perform further analysis, for example, by pattern recognition applications. A HMM can be considered as the simplest dynamic Bayesian network, as known in the art.

In a regular Markov model, the state is directly visible to the observer, and therefore the state transition probabilities are the only parameters. In a hidden Markov model, the state is not directly visible, but variables influenced by the state are visible. Each state has a probability distribution over the possible output tokens. Therefore the sequence of tokens generated by an HMM gives some information about the sequence of states.

The speech recognition techniques may also use, but are not limited to Dynamic Programming, and Neuronal Network. Dynamic Programming is a method of solving problems exhibiting the properties of overlapping sub-problems and optimal substructure. A neural network is a computing paradigm that is loosely modeled after cortical structures of the brain. It consists of interconnected processing elements called neurons that work together to produce an output function. The output of a neural network relies on the cooperation of the individual neurons within the network to operate. Processing of information by neural networks is often done in parallel rather than in series (or sequentially). Since it relies on its member neurons collectively to perform its function, a unique property of a neural network is that it can still perform its overall function even if some of the neurons are not functioning. As a result, neural networks are very resistant to error or failure (i.e., fault tolerant).

Finally, returning to FIG. 5, the textual sequence may be sent 530 to the called party. For example, the textual sequence may be sent to the called party in an SMS message, as described in further detail hereinabove.

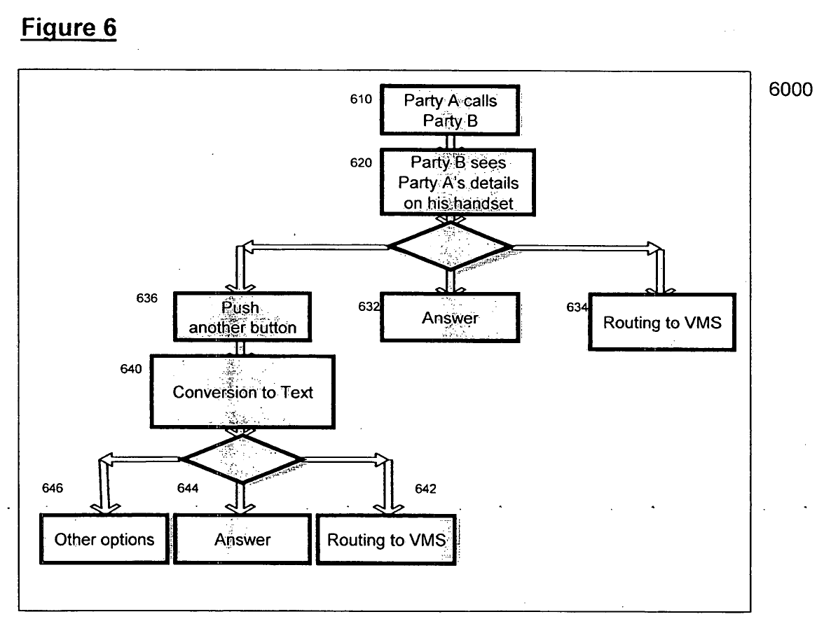

Reference is now made to FIG. 6, which is a flowchart illustrating a second method for text messaging in a telephony network in accordance with an exemplary embodiment of the present invention. In method 6000, if a party A calls a party B 610 and party B sees 620 the attempt to call him on the screen of his mobile telephony unit, party B may choose to answer 632 the call. Party B may also allow the call to be routed to a Voice Mail Service 634 by ignoring the call or by pushing a certain button on the mobile telephony unit.

Party B may also choose to subject the incoming call to voice-to-text conversion, to be carried out by a converter 120, as described in further detail hereinabove. For example, party B may push a predefined button 636 on the mobile telephony unit. Then, the client agent 405 installed on the mobile telephony unit communicates party B's decision to subject the incoming call to the voice-to-text conversion, as described in further detail hereinabove.

The capturer 110 captures words spoken by party A, for example, in a voice message left at the voice message receiver 115 described in further detail hereinabove. Next, one or more of the words spoken by party A are automatically converted 640 in real time to a textual sequence including the converted words, as described in further detail hereinabove. The text sequence is sent to the party B's mobile telephony unit. Optionally, the text sequence is sent to party B's mobile telephony unit as an SMS message.

Finally, Party B may be allowed to issue a response 646 order. For example, Party B may be allowed to choose amongst a number of predefined response orders. The response order may be received by the response receiver 140 and executed by the response executer 160, as described in further detail hereinabove. Party B may also choose to answer the call 644 by being reconnected to party A. Party B may also choose to trigger the routing of party A to Voice Messaging Service (VMS) 642, as described in further detail hereinabove.

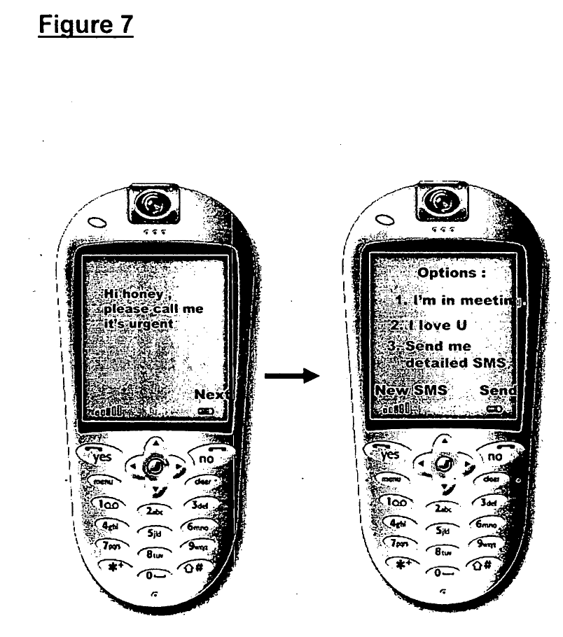

Reference is now made to FIG. 7, which illustrates messages presented on a called party's handset screen in accordance with an exemplary embodiment of the present invention. As the called party receives the text sequence resulting from the conversion of the words spoken by the calling party into text, the called party may choose amongst several predefined response options, as described in further detail hereinabove. For example, upon receiving an SMS bearing the sequence of words spoken by the calling party 710, the called party may be allowed to choose amongst a list of predefined response orders 720, as described in further detail hereinabove.

The invention is capable of other embodiments or of being practiced or carried out in various ways. Also, it is to be understood that the phraseology and terminology employed herein is for the purpose of description and should not be regarded as limiting.

It is expected that during the life of this patent many relevant devices and systems will be developed and the scope of the terms herein, particularly of the terms “Phone” “Network”, “Cellular”, Network”, “Telephony”, “SMS”, and “MSC”, is intended to include all such new technologies a priori.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination.

Implementation of methods and systems in accordance with embodiments of the present invention involves performing or completing certain selected tasks or steps manually, automatically, or a combination thereof. Moreover, according to actual instrumentation and equipment of preferred embodiments of the method and system of the present invention, several selected steps could be implemented by hardware or by software on any operating system of any firmware or a combination thereof. For example, as hardware, selected steps of the invention could be implemented as a chip or a circuit. As software, selected steps of the invention could be implemented as a plurality of software instructions being executed by a computer using any suitable operating system. In any case, selected steps of the method and system of the invention could be described as being performed by a data processor, such as a computing platform for executing a plurality of instructions.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

What is claimed is:

1. An apparatus for call enhancement in association with telephone calls in a telephony network, comprising:
a capturer configured to capture at least one word spoken by a calling party of a phone call, wherein the capturer operates according to a predetermined capturing policy; and
a converter in communication with the capturer and configured to automatically convert at least one of the at least one captured word into a textual sequence.

2. The apparatus of claim 1, further comprising:
a voice message receiver in communication with the capturer and configured to allow the calling party of the phone call to leave a voice message comprising the spoken words to a called party of the phone call.

3. The apparatus of claim 1, further comprising:
a text message sender in communication with the converter and configured to send a text message containing the textual sequence to a called party of the phone call.

4. The apparatus of claim 1, further comprising:
a response receiver in communication with the capturer and configured to receive a response order in response to the text message from a called party of the phone call.

5. The apparatus of claim 4, wherein the response order comprises a prerecorded voice message.

6. The apparatus of claim 4, wherein the response order comprises a text message.

7. The apparatus of claim 4, further comprising:
a response executer in communication with the response receiver and configured to execute the response order received from the called party to the calling party.

8. The apparatus of claim 1, wherein the converter is further configured to automatically convert all of the at least one captured word into the textual sequence.

9. The apparatus of claim 1, further comprising:
at least one switch in communication with at least one of the converter and the capturer, wherein the at least one switch controls access to at least one of the converter and the capturer.

10. The apparatus of claim 1, wherein the telephony network is a cellular telephony network.

11. A method for call enhancement in association with telephone calls in a telephony network, comprising:
capturing at least one word spoken by a calling party of a phone call wherein the capturing is performed according to a predetermined capturing policy; and
automatically converting at least one of the at least one captured word into a textual sequence.

12. The method of claim 11, further comprising:
allowing the calling party of the phone call to leave a voice message comprising the spoken words to a called party of the phone call.

13. The method of claim 11, further comprising:
sending a text message containing the textual sequence to a called party of the phone call.

14. The method of claim 11, further comprising:
receiving a response order from a called party of the phone call.

15. The method of claim 14, wherein the response order is a prerecorded voice message.

16. The method of claim 14, wherein the response order is a text message.

17. The method of claim 11, further comprising:
sending a response order provided by a called party to the calling party.

18. The method of claim 11, wherein the converting comprises automatically converting all of the at least one captured word into a textual sequence.

19. A system for call enhancement in association with telephone calls in a telephony network, comprising:
a capturer deployed in the telephony network and configured to capture at least one word spoken by a calling party of a phone call, wherein the capturer operates according to a predetermined capturing policy;
b) a converter in communication with the capturer and configured to automatically convert at least one of the at least one captured word into a textual sequence; and
c) a client agent installed at a remote unit and configured to communicate with the capturer in order to trigger the capturing of the at least one word by the capturer.

20. A client agent embodied on a computer readable medium and installable on a mobile telephony device, wherein the client agent is configured to communicate with an apparatus in order to trigger capturing of words spoken by a calling party to a text message, and wherein the client agent is further configured to receive the text message from the apparatus and present the text message on a screen of the mobile telephony device.
